(19) United States
(12) Patent Application Publication
(10) Pub. No.: US 2005/0227023 A1
(43) Pub. Date: Oct. 13, 2005

(54) Thermal transfer sheet with dye layer containing specific polyol resin

(76) Inventors: Tomoko Araki, Shinjuku-ku (JP); Mitsuru Maeda, Shinjuku-ku (JP); Munenori Ieshige, Shinjuku-ku (JP); Hiroyuki Morikane, Yokohama-shi (JP); Takao Matsumura, Yokohama-shi (JP)

Correspondence Address: BIRCH STEWART KOLASCH & BIRCH, PO BOX 747, FALLS CHURCH, VA, 22040-0747, US

(21) Appl. No.: 11/093,307

(22) Filed: Mar. 30, 2005

(30) Foreign Application Priority Data
Mar. 31, 2004 (JP) 2004-105283

(51) Int. Cl. B41M 5/40

(52) U.S. Cl. 428/32.67

(57) ABSTRACT

The present invention relates to a thermal transfer sheet, comprising a substrate; a heat-resistant sliding layer provided on one surface of the substrate; and a dye layer comprising at least a dye and a binder resin provided on the other surface of the substrate, wherein the binder resin comprises a styrene-containing polyol resin, which which meets a demand for speeding up of printing speed of thermal transfer, and densification and quality improvement of thermally transferred images, particularly meets to a demand for densification of thermally transferred images and in which the migration of dyes to the heat-resistant sliding layer and the scumming are prevented.

### BACKGROUND OF THE INVENTION

1. Field of the Invention

The present invention relates to a thermal transfer sheet comprising a substrate, a heat-resistant sliding layer provided on one surface of the substrate, and a dye layer comprising at least a dye which transfers to an image-receiving sheet upon heating and a binder resin, the dye layer being provided on the other surface of the substrate.

2. Description of the Related Art

Conventionally, various thermal transfer recording methods are known. For example, a method is proposed in which sublimation-transferable dyes are thermally transferred from a thermal transfer sheet comprising a substrate, such as a polyester film, having thereon a dye layer in which the sublimation-transferable dyes as recording agents are supported with a binder resin, to an image-receiving sheet comprising a material to be transferred with sublimable dyes such as paper and plastic films and a dye-receiving layer provided on the material, thereby various full-color images are formed. In this method, a large number of color dots of three or four colors with regulated thermal dose are transferred onto the image-receiving layer of an image-receiving sheet upon heating by heating means, such as a thermal head of a printer, whereby full color of an original document is reproduced by the multicolor dots. Since colorants used are dyes which are very vivid and highly transparent, the formed images have excellent reproducibility and gradation of intermediate colors and have high quality which is equal to images produced by conventional offset printing and gravure printing and is comparable to the quality of full-color photographic images.

In such thermal transfer recording system using sublimation transfer, a recent increase in printing speed in thermal transfer printers, however, has caused a problem that conventional thermal transfer sheets cannot provide satisfactory printing densitity. Recently, articles with images printed by thermal transfer have been required to be of higher density and clearness. There, therefore, have been made many attempts of improving thermal transfer sheets and image-receiving sheets on which images are formed through reception of sublimable dyes transferred from thermal transfer sheets.

For example, the improvement in transfer density has been attempted through reduction of the thickness of thermal transfer sheets. However, this will cause problems in that thermal transfer sheets tend to wrinkle due to the heat or pressure applied during their production, and printed articles wrinkle and thermal transfer sheets break during thermal transfer recording.

Further, an attempt to improve the printing densitity by increasing the dye/resin (dye/binder) ratio in the dye layer of the thermal transfer sheet has been made. In this case, however, during storage in a wound state, the dye is transferred onto the heat-resistant sliding layer provided on the backside of the thermal transfer sheet, and, at the time of roll back, the transferred dye is retransferred (kick-backed) to dye layers of other colors or the like. When the contaminated layers are thermally transferred to an image-receiving sheet, hue different from a designated one is produced, or otherwise there occurs scumming, which is coloring of an unprinted area (an area which is not heated by a thermal head) at the time of printing.

There have been made attempts to improve the printing densitity and prevent abnormal transfer through improvement of binder resin of dye layers. Patent document 1 discloses an acrylic polyol resin as one example of active hydrogen-containing binder resin. In Patent document 1, for the purpose of obtaining a highly heat-resistant binder resin which is needed in the printing method in which recording is made by conveying a thermal transfer sheet slower than a sheet to be transferred (the image-receiving sheet) when printing is conducted with the thermal transfer sheet and the sheet to be transferred superposed, a combination of polyol resin and isocyanate is used; the polyol resin is used merely as a reaction site with isocyanate.

There is another attempt in which a high energy is applied to a thermal transfer printer rather than a thermal transfer sheet during thermal transfer for image formation. However, the dye layer and the receiving layer are fused to each other, tending to cause so-called abnormal transfer. If a large amount of release agent is added to the dye layer or the dye-receiving layer for preventing such abnormal transfer, image blurring of images, scumming and the like will occur.

For meeting a demand for densification and quality improvement of thermally transferred images, there have been made adjustment of thermal transfer printers and improvement of thermal transfer recording materials of thermal transfer sheets and image-receiving sheets to be used. However, sufficient image density has not been achieved or abnormal transfer has occurred during thermal transfer recording and, therefore, printed articles of satisfactory quality have not been obtained.

[Patent document] Japanese Patent Application Laid-Open No. 61-106296

### BRIEF SUMMARY OF THE INVENTION

The present invention is to provide a thermal transfer sheet in which migration of dyes to the heat-resistant sliding layer and occurrence of scumming are prevented while requirement of densification of thermally transferred images is met.

The present invention relates to a thermal transfer sheet, comprising a substrate; a heat-resistant sliding layer provided on one surface of the substrate; and a dye layer comprising at least a dye and a binder resin provided on the other surface of the substrate,
wherein the binder resin comprises a styrene-containing polyol resin.

### BRIEF DESCRIPTION OF THE DRAWINGS

FIG. 1 is a schematic cross-sectional view showing one embodiment of a thermal transfer sheet of the present invention.

FIG. 2 is a schematic cross-sectional view showing another embodiment of a thermal transfer sheet of the present invention.

### DETAILED DESCRIPTION OF THE INVENTION

The object of the present invention can be attained by constituting a thermal transfer sheet comprising a substrate, a heat-resistant sliding layer provided on one surface of the substrate, and a dye layer comprising at least a dye and a binder resin provided on the other surface of the substrate wherein the binder resin comprises a styrene skeleton-containing polyol resin (first invention).

A second invention is characterized in that the binder resin in the first invention is a styrene skeleton-containing acrylic polyol resin.

A third invention is characterized in that the styrene skeleton-containing polyol resin of the first or second invention has a glass transition temperature (Tg) of 40° C. or higher.

The thermal transfer sheet of the present invention exerts high transfer density (printing density), can restrain migration of dyes to its heat-resistant sliding layer and occurrence of scumming and is excellent in printing properties.

The thermal transfer sheet of the present invention meets the requirement of speeding up of thermal transfer printing speed, increase in density of thermal transfer images and improvement of quality of thermal transfer images.

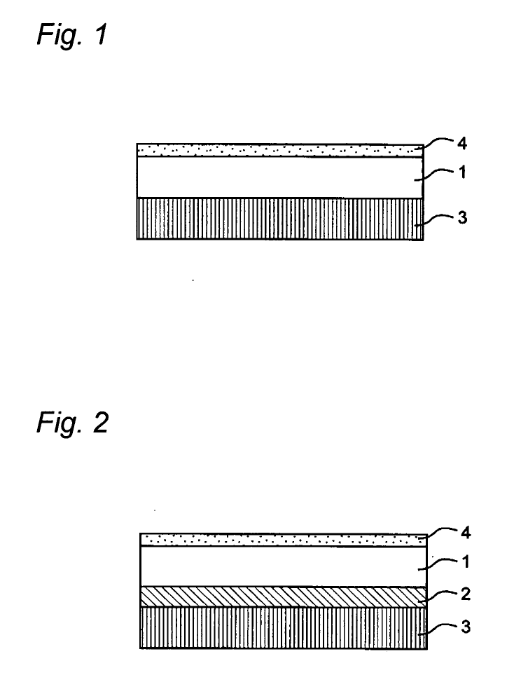

FIG. 1 shows a schematic cross-sectional view of a thermal transfer sheet which is one embodiment of the present invention. The thermal transfer sheet shown in FIG. 1 has a constitution in which a heat-resistant sliding layer 4 for improving the sliding property of a thermal head and for preventing sticking is formed on one surface of the substrate 1 and a dye layer 3 is formed on the other side of the substrate 1.

(Substrate)

As the substrate 1 of the thermal transfer sheet for use in the present invention, any conventionally known substrate may be used as long as it has appropriate heat resistance and appropriate strength. Examples of such a substrate include films having a thickness approximately from 0.5 to 50 μm, preferably from 1 to 10 μm, e.g. polyethylene terephthalate film, 1,4-polycyclohexylenedimethylene terephthalate film, polyethylene naphthalate film, polyphenylenesulfide film, polystyrene film, polypropylene film, polysulfone film, aramid film, polycarbonate film, polyvinyl alcohol film, cellophane, cellulose derivatives such as cellulose acetate, polyethylene film, polyvinylchloride film, nylon film, polyimide film and ionomer film.

The substrate 1 is often subjected to adhesiveness-improving treatment on its surface on which a dye layer and an adhesive layer described below are formed. As the adhesiveness-improving treatment, conventional techniques for resin surface modification may be applied, such as corona discharging treatment, flame treatment, ozone treatment, UV treatment, radiation treatment, roughening treatment, chemical treatment, plasma treatment, low temperature plasma treatment, primer treatment and grafting treatment. Two or more of these treatments may be used in combination. The primer treatment may be carried out, for example, by applying a primer solution to an un-stretched film during film forming by melt extrusion of a plastic film and then stretching the film.

(Dye Layer)

The dye layer may be composed of a monocolor single layer. Alternatively, two or more dye layers containing dyes with different hues are formed sequentially and repeatedly on the same surface of the same substrate. The dye layer is a layer in which a thermally migratable dye is supported in a desired binder. Any dye which is melted, diffused or sublimed by heat to migrate and which is used in conventionally known sublimation transfer-type thermal transfer sheets may be used for the present invention as a dye. The amount of the dye to be contained in the dye layer may be an amount conventionally used and usually is within the range from 30 to 300 parts by weight based on 100 parts by weight of the binder resin.

Examples of the dye include diarylmethane dyes; triarylmethane dyes; thiazole dyes; methine dyes, such as merocyanine and pyrazolonemethine; azomethine dyes exemplified by indoaniline, acetophenoneazomethine, pyrazoloazomethine, imidazole azomethine, imidazoazomethine, and pyridone azomethine; xanthene dyes; oxazine dyes; cyanomethylene dyes exemplified by dicyanostyrene and tricyanostyrene; thiazine dyes; azine dyes; acridine dyes; benzene azo dyes; azo dyes exemplified by pyridone azo, thiophene azo, isothiazole azo, pyrrole azo, pyrazole azo, imidazole azo, thiadiazole azo, triazole azo and disazo dyes; spiropyran dyes; indolinospiropyran dyes; fluoran dyes; rhodamine lactam dyes; naphthoquinone dyes; anthraquinone dyes; and quinophthalone dyes. Among these dyes, a proper dye is selected and used taking into account characteristics such as hue, printing density, light stability, storage stability and solubility in binder.

The binder resin constituting the dye layer in the thermal transfer sheet of the present invention contains a polyol resin having a styrene skeleton introduced, which is hereinafter referred simply to as a “styrene-containing polyol resin”. By introduction of a styrene skeleton, the printing densitity is improved and the dye migration to the heat-resistant sliding layer and the occurrence of scumming are prevented.

The styrene-containing polyol resin is a polymer which contains at least styrene or styrene derivative as a structural unit and also has a hydroxyl group. There are not limitations other than those mentioned above. Examples thereof include copolymers formed of one or more of the following monomers;
styrene and styrene derivatives (hereinafter referred to as “styrene-type monomers”), such as α-methylstyrene, vinyltoluene and p-chlorostyrene;
C2-C8 hydroxyalkyl esters of acrylic acid or methacrylic acid (hereinafter referred to as “hydroxyalkyl (meth)acrylate”, such as hydroxyethyl methacrylate, hydroxyethyl acrylate, hydroxypropyl acrylate, hydroxypropyl methacrylate, hydroxybutylacrylate and hydroxybutyl methacrylate;
C1-C18 alkyl esters of acrylic acid or methacrylic acid (hereinafter referred to as “alkyl (meth)acrylate”), such as methyl methacrylate, methyl acrylate, ethyl methacrylate, ethyl acrylate, isopropyl methacrylate, isopropyl acrylate, propyl methacrylate, propyl acrylate, butyl methacrylate, butyl acrylate, hexyl methacrylate, hexyl acrylate, octyl methacrylate, octyl acrylate, lauryl methacrylate, lauryl acrylate and stearyl methacrylate;
C2-C18 alkoxyalkyl esters of acrylic acid or methacrylic acid (hereinafter referred to as “alkoxyalkyl (meth)acrylate”), such as methoxybutyl methacrylate, methoxybutyl acrylate, methoxyethyl methacrylate, methoxyethyl acrylate, ethoxybutyl methacrylate and ethoxybutyl acrylate; and
other copolymerizable monomers (hereinafter referred to as “additional copolymerizable monomere”), such as acrylonitrile, methacrylonitrile, acrylamide, N-methylolmethacrylamide, N-methylolacrylamide, N-methylolacrylamide butyl ether, dimethylaminoethyl methacrylate, diethylaminoethyl methacrylate, methacrylic acid, acrylic acid, vinyl acetate, allyl alcohol and maleic acid.

Preferred are styrene-containing acrylic polyol resins including a styrene-type monomer and hydroxyalkyl (meth)acrylate as constitutional monomer units. The copolymerization ratio (molar ratio) is 95:5-5:95, preferably 85:15-15:85 (styrene-type monomer:hydroxyalkyl (meth)acrylate). If the ratio of the styrene-type monomer is too large, it becomes difficult to obtain a satisfactory ink stability due to, for example, dye deposition. If it is too small, it is impossible to obtain a high printing densitity.

The styrene-containing acrylic polyol resin may include a copolymerizable monomer other than styrene-type monomers and hydroxyalkyl (meth)acrylate, for example, the above-mentioned alkoxyalkyl (meth)acrylate and additional copolymerizable monomer such as acrylonitrile. However, it is desirable to set the amount thereof to be 80 mol % or less.

The styrene-containing polyol resin is produced by various conventional polymerization methods such as radical polymerization and ionic polymerization. Such resin is available as COATAX LH635 (trade name, acrylic polyol resin manufactured by Toray Fine Chemicals Co., Ltd.) and as Acryt 6AN-213 (trade name, acrylic polyol resin manufactured by Taisei Kako Co., Ltd.).

The glass transition temperature of the styrene-containing polyol resin is 40° C. or higher, preferably 40-110° C. If the glass transition temperature is lower than 40° C., the migration of dyes to the heat-resistant sliding layer or the scumming will occur noticeably during storage of an ink ribbon and the dye layer may cause blocking with the heat-resistant sliding layer. If a styrene-containing polyol resin having a too high glass transition temperature is used, the effect of improvement in printing densitity cannot be expected.

The styrene-containing polyol resin is used in a ratio of 10-100% by weight, preferably 20-100% by weight based on the resin constituting the dye layer. Use of the resin in a ratio less than 10% by weight is undesirable because it is impossible to obtain a high transfer density.

Examples of resin components which may be added to the dye layer in addition to the styrene-containing polyol resin include cellulose resins such as ethyl cellulose, hydroxyethyl cellulose, hydroxypropyl cellulose, methyl cellulose, cellulose acetate and cellulose acetate butyrate; vinyl-resins such as polyvinyl acetate, polyvinyl alcohol, polyvinyl butyral, polyvinyl acetoacetal and polyvinyl pyrrolidone; acrylic resins such as poly(meth)acrylate and poly(meth)acrylamide; polyurethane-resins, polyamide-resins and polyester-resins. In particular, cellulose resins, polyvinyl butyral, polyvinyl alcohol, polyvinyl acetoacetal and polyester resins, which are superior in heat resistance, storage stability (resistance to dye migration or scumming), are preferably used. In particular, polyvinyl butyral, polyvinyl acetoacetal are preferable as a resin component for use in combination with the styrene-containing polyol resin. When these resins are used in combination with the styrene-containing polyol resin, it is preferable that the styrene-containing polyol resin is contained at a content of 20-80% by weight in the resin components.

To the dye layer, various conventionally known additives may be added if necessary. Examples of such additives include organic fine particles such as polyethylene wax, inorganic fine particles, silicone oil and phosphate ester and the like, which are used for improving releasability from image-receiving sheets or coatability of ink.

The dye layer can be usually formed by adding a dye, a binder resin and, if necessary, desired additives to a proper solvent and dissolving or dispersing the ingredients to give a coating solution, applying the coating solution to a substrate and then drying the solution. With respect to the application method, the coating solution is applied by conventionally known means such as a gravure printing method, a screen printing method and a reverse roll coating method using a gravure plate so as to give a coating amount of 0.1 to 6.0 g/m², preferably 0.2 to 3.0 g/m² after dried.

The thermal transfer sheet of the present invention may be provided with an adhesive layer 2 between the substrate 1 and the dye layer 3 as shown in FIG. 2.

(Adhesive Layer)

Any known adhesive layer may be used as the adhesive layer 2. Preferred is the one which adheres firmly to both the substrate and the dye layer for prevention of abnormal transfer and to which the dye hardly transfers for prevention of decrease in printing densitity. Examples of such adhesive layer include polyester resins, polyacrylic acid ester resins, polyvinyl acetate resins, polyurethane resins, styrene-acrylate resins, polyacrylaminde resins, polyamide resins, polyether resins, polystyrene resins, polyethylene resins, polypropylene resins, vinyl-resins such as polyvinyl chloride resin, polyvinyl alcohol resin and polyvinyl pyrrolidone resin, and polyvinyl acetal resins such as polyvinyl acetoacetal and polyvinyl butyral.

The adhesive layer can be formed by dissolving or dispersing materials in a proper solvent to prepare a coating solution and the solution is applied by a forming means, for example, a gravure printing method, a screen printing method and a reverse roll coating method using a gravure plate, and then dried. To the coating solution for adhesive layer, additives such as fluorescent whitening agent, filler and the like may be added. The adhesive layer is formed so as to have a thickness of 0.01 to 2.0 g/m² after dried.

(Heat-Resistant Sliding Layer)

The heat-resistant sliding layer, which is provided for preventing adverse effects such as sticking or wrinkling at the time of printing caused by the heat of a thermal head, comprises a resin, a sliding property-giving agent and, if desired, filler.

The resin for forming the heat-resistant sliding layer may be conventionally known resins such as polyvinyl butyral resins, polyvinyl acetoacetal resins, polyester resins, vinyl chloride-vinyl acetate copolymers, polyether resins, polybutadiene resins, styrene-butadiene copolymers, acrylic polyols, polyurethaneacrylates, polyester acrylates, polyether acrylates, epoxyacrylates, urethane or epoxy prepolymers, nitrocellulose resins, cellulose nitrate resins, cellulose acetate propionate resins, cellulose acetate butylate resins, cellulose acetate hydrodienephthalate resins, cellulose acetate resins, aromatic polyamide resins, polyimide resins, polyamideimide resins, polycarbonate resins and chlorinated polyolefin resins.

The sliding property-giving agent is added to or topcoated on the heat-resistant sliding layer. Examples thereof include higher fatty acid metal salts, nylon filler, phosphate esters, silicone oils, graphite powders, silicone-based graft polymers, fluorine-containing graft polymers and silicone polymers such as acrylic silicone graft polymers, acrylic siloxanes and aryl siloxanes. The heat-resistant sliding layer is preferably a layer comprising a polyol, for example, a high-molecular polyalcohol compound, a polyisocyanate compound and a phosphate ester compound. Further, the addition of a filler is more preferred.

The heat-resistant sliding layer may be formed by dissolving or dispersing a resin, a sliding property-giving agent and, if desired, a filler in a proper solvent to prepare a coating solution and the solution is applied to a substrate sheet by a forming means such as a gravure printing method, a screen printing method, or a reverse roll coating method using a gravure plate, and drying the solution. The heat-resistant sliding layer is formed so as to have a thickness of 0.1 to 3.0 g/m² after dried.

### EXAMPLES

The present invention is explained in more detail with reference to the following Examples. In the Examples, “parts” or “%” is by weight unless otherwise specified.

### Example 1

A polyethylene terephthalate (PET) film having a thickness of 6 μm (Diafoil K880, manufactured by Mitsubishi Polyester Film Corporation), which was used as a substrate, was subjected to a corona treatment. To the corona-treated surface of the substrate, an adhesive layer composition solution a having the following composition was applied by a gravure coating method so as to give the coverage on a dry basis of 0.2 g/m², and the resultant coating was dried to provide an adhesive layer. Further on the adhesive layer, a dye layer composition solution A having the following composition was applied by a gravure coating method so as to give the coverage on a dry basis of 0.8 g/m², and the resultant coating was dried to give a thermal transfer sheet of Example 1. On the other surface of the substrate, a heat-resistant sliding layer composition solution (i) having the following composition was in advance applied by a gravure coating method so as to give the coverage on a dry basis of 1.0 g/m², and the resultant coating was dried to provide a heat-resistant sliding layer.

| <Adhesive Layer Composition Solution a> | | |
|---|---|---|
| Polyvinyl pyrrolidone resin (K-90, | 5 | parts |
| manufactured by ISP Japan Co., Ltd.) | | |
| Methyl ethyl ketone | 47.5 | parts |
| Isopropyl alcohol | 47.5 | parts |
| <Dye Layer Composition Solution A> | | |
| Disperse Yellow 201 | 2.0 | parts |
| Disperse Yellow 231 | 2.0 | parts |
| Styrene skeleton-introduced acrylic | 8.0 | parts |
| polyol resin (Tg: 50° C.) | | |
| (Acryt 6AN-213 (50 wt % solution) | | |
| manufactured by Taisei Kako Co., Ltd.) | | |
| Methyl ethyl ketone | 44 | parts |
| Toluene | 44 | parts |

<Heat-Resistant Sliding layer Composition Solution (i)>

| | | |
|---|---|---|
| Polyvinyl butyral resin (S-LEC BX-1, | 13.6 | parts |
| manufactured by Sekisui Chemical Co., Ltd.) | | |
| Polyisocyanate curing agent (Takenate D218, | 0.6 | parts |
| manufactured by Takeda Pharmaceutical Co., Ltd.) | | |
| Phosphate (Plysurf A208S, manufactured | 0.8 | parts |
| by DAI-ICHI KOGYO SEIYAKU Co., Ltd.) | | |
| Methyl ethyl ketone | 42.5 | parts |
| Toluene | 42.5 | parts |

### Example 2

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution B having the following composition was applied by a gravure coating method so as to give the coverage on a dry basis of 0.8 g/m², and the resultant coating was dried to give a thermal transfer sheet of Example 2.

<Dye Layer Composition Solution B>

| | | |
|---|---|---|
| Disperse Yellow 201 | 2.0 | parts |
| Disperse Yellow 231 | 2.0 | parts |
| Styrene skeleton-introduced acrylic polyol | 6.67 | parts |
| resin (Tg: 85° C.) | | |
| (COATAX LH-635 (60 wt % solution) manufactured | | |
| by Toray Fine Chemicals Co., Ltd.) | | |
| Methyl ethyl ketone | 44.66 | parts |
| Toluene | 44.67 | parts |

### Example 3

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution C having the following composition was applied by a gravure coating method so as to give the coverage on a dry basis of 0.8 g/m², and the resultant coating was dried to give a thermal transfer sheet of Example 3.

<Dye Layer Composition Solution C>

| | | |
|---|---|---|
| Disperse Yellow 201 | 2.0 | parts |
| Disperse Yellow 231 | 2.0 | parts |
| Styrene skeleton-introduced acrylic polyol | 7.41 | parts |
| resin (Tg: 73° C.) | | |
| (Acryt 6FL-1034 (54 wt % solution) | | |
| manufactured by Taisei Kako Co., Ltd.) | | |
| Methyl ethyl ketone | 44.29 | parts |
| Toluene | 44.30 | parts |

### Example 4

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution D having the following composition was applied by a gravure coating method so as to give the coverage on a dry basis of 0.8 g/m², and the resultant coating was dried to give a thermal transfer sheet of Example 4.

<Dye Layer Composition Solution D>

| | | |
|---|---|---|
| Disperse Yellow 201 | 2.0 | parts |
| Disperse Yellow 231 | 2.0 | parts |
| Styrene skeleton-introduced acrylic polyol | 8.25 | parts |
| resin (Tg: 56° C.) | | |
| (Acryt 6BZ-318 (48.5 wt % solution) | | |
| manufactured by Taisei Kako Co., Ltd.) | | |
| Methyl ethyl ketone | 43.87 | parts |
| Toluene | 43.88 | parts |

### Example 5

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution E having the following composition was applied by a gravure coating method so as to give the coverage on a dry basis of 0.8 g/m², and the resultant coating was dried to give a thermal transfer sheet of Example 5.

<Dye Layer Composition Solution E>

| | | |
|---|---|---|
| Solvent Blue 63 | 3.0 | parts |
| Disperse Blue 354 | 2.0 | parts |
| Styrene skeleton-introduced acrylic polyol | 8.0 | parts |
| resin (Tg: 50° C.) | | |
| (Acryt 6AN-213 (50 wt % solution) manufactured | | |
| by Taisei Kako Co., Ltd.) | | |
| Methyl ethyl ketone | 43.5 | parts |
| Toluene | 43.5 | parts |

### Example 6

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution F having the following composition was applied by a gravure coating method so as to give the coverage on a dry basis of 0.8 g/m², and the resultant coating was dried to give a thermal transfer sheet of Example 6.

<Dye Layer Composition Solution F>

| | | |
|---|---|---|
| Disperse Yellow 201 | 2.0 | parts |
| Disperse Yellow 231 | 2.0 | parts |
| Styrene skeleton-introduced acrylic polyol | 4.0 | parts |
| resin (Tg: 50° C.) | | |
| (Acryt 6AN-213 (50 wt % solution) manufactured by | | |
| Taisei Kako Co., Ltd.) | | |
| Polyvinyl butyral resin (Tg: 86° C.) | 2.0 | parts |
| (S-LEC BX-5, manufactured by Sekisui Chemical | | |
| Co., Ltd.) | | |
| Methyl ethyl ketone | 45.0 | parts |
| Toluene | 45.0 | parts |

### Example 7

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution G having the following composition was applied by a gravure coating method so as to give the coverage on a dry basis of 0.8 g/m², and the resultant coating was dried to give a thermal transfer sheet of Example 7.

<Dye Layer Composition Solution G>

| | | |
|---|---|---|
| Disperse Yellow 201 | 2.0 | parts |
| Disperse Yellow 231 | 2.0 | parts |
| Styrene skeleton-introduced acrylic polyol | 3.33 | parts |
| resin (Tg: 85° C.) | | |
| (COATAX LH-635 (60 wt % solution) manufactured | | |
| by Toray Fine Chemicals Co., Ltd.) | | |
| Polyvinyl butyral resin (Tg: 86° C.) | 2.0 | parts |
| (S-LEC BX-5, manufactured by Sekisui Chemical | | |
| Co., Ltd.) | | |
| Methyl ethyl ketone | 45.33 | parts |
| Toluene | 45.34 | parts |

### Example 8

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution H having the following composition was applied by a gravure coating method so as to give the coverage on a dry basis of 0.8 g/m², and the resultant coating was dried to give a thermal transfer sheet of Example 8.

<Dye Layer Composition Solution H>

| | | |
|---|---|---|
| Disperse Yellow 201 | 2.0 | parts |
| Disperse Yellow 231 | 2.0 | parts |
| Styrene skeleton-introduced acrylic polyol | 4.0 | parts |
| resin (Tg: 50° C.) | | |
| (Acryt 6AN-213 (50 wt % solution) manufactured | | |
| by Taisei Kako Co., Ltd.) | | |
| Polyvinyl acetoacetal resin (Tg: 110° C.) | 2.0 | parts |
| (S-LEC KS-5, manufactured by Sekisui Chemical | | |
| Co., Ltd.) | | |
| Methyl ethyl ketone | 45.0 | parts |
| Toluene | 45.0 | parts |

### Example 9

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution I having the following composition was applied by a gravure coating method so as to give the coverage on a dry basis of 0.8 g/m², and the resultant coating was dried to give a thermal transfer sheet of Example 9.

<Dye Layer Composition Solution I>

| | | |
|---|---|---|
| Disperse Yellow 201 | 2.0 | parts |
| Disperse Yellow 231 | 2.0 | parts |
| Styrene skeleton-introduced acrylic | 4.0 | parts |
| polyol resin (Tg: 50° C.) | | |
| (Acryt 6AN-213 (50 wt % solution) | | |
| manufactured by Taisei Kako Co., Ltd.) | | |
| Cellulose acetate butyrate resin (Tg: 141° C.) | 2.0 | parts |
| (CAB 381-20, manufactured by | | |
| Eastman Chemical Company) | | |
| Methyl ethyl ketone | 45.0 | parts |
| Toluene | 45.0 | parts |

### Example 10

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution J having the following composition was applied by a gravure coating method so as to give the coverage on a dry basis of 0.8 g/m², and the resultant coating was dried to give a thermal transfer sheet of Example 10.

<Dye Layer Composition Solution J>

| | | |
|---|---|---|
| Solvent Blue 63 | 3.0 | parts |
| Disperse Blue 354 | 2.0 | parts |
| Styrene skeleton-introduced acrylic | 4.0 | parts |
| polyol resin (Tg: 50° C.) | | |
| (Acryt 6AN-213 (50 wt % solution) | | |
| manufactured by Taisei Kako Co., Ltd.) | | |
| Polyvinyl butyral resin (Tg: 86° C.) | 2.0 | parts |
| (S-LEC BX-5, manufactured by Sekisui | | |
| Chemical Co., Ltd.) | | |
| Methyl ethyl ketone | 44.5 | parts |
| Toluene | 44.5 | parts |

### Example 11

A polyethylene terephthalate (PET) film having a thickness of 6 μm (Diafoil K203E, manufactured by Mitsubishi Polyester Film Corporation) was used as a substrate. The film was treated in advance to improve adhesiveness. A heat-resistant sliding layer as same as that of Example 1 was formed in advance on the surface opposite to the adhesiveness-improved surface. On the adhesiveness-improved surface of the substrate, a dye layer composition solution F which was used also in Example 6 was applied by a gravure coating method, without coating of an adhesive layer, so as to give the coverage on a dry basis of 0.8 g/m², and the resultant coating was dried to give a thermal transfer sheet of Example 11.

### Example 12

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution K having the following composition was applied by a gravure coating method so as to give the coverage on a dry basis of 0.8 g/m², and the resultant coating was dried to give a thermal transfer sheet of Example 12.

<dye layer composition solution K>

| | | |
|---|---|---|
| Disperse Yellow 201 | 2.0 | parts |
| Disperse Yellow 231 | 2.0 | parts |
| Styrene skeleton-introduced acrylic | 1.6 | parts |
| polyol resin (Tg: 50° C.) | | |
| (Acryt 6AN-213 (50 wt % solution) | | |
| manufactured by Taisei Kako Co., Ltd.) | | |
| Polyvinyl butyral resin (Tg: 86° C.) | 3.2 | parts |
| (S-LEC BX-5, manufactured by Sekisui | | |
| Chemical Co., Ltd.) | | |
| Methyl ethyl ketone | 45.6 | parts |
| Toluene | 45.6 | parts |

### Example 13

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution L having the following composition was applied by a gravure coating method so as to give the coverage on a dry basis of 0.8 g/m², and the resultant coating was dried to give a thermal transfer sheet of Example 13.

<Dye Layer Composition Solution L>

| | | |
|---|---|---|
| Disperse Yellow 201 | 2.0 | parts |
| Disperse Yellow 231 | 2.0 | parts |
| Styrene skeleton-introduced acrylic | 1.33 | parts |
| polyol resin (Tg: 85° C.) | | |
| (COATAX LH-635 (60 wt % solution) | | |
| manufactured by Toray Fine | | |
| Chemicals Co., Ltd.) | | |
| Polyvinyl butyral resin (Tg: 86° C.) | 3.2 | parts |
| (S-LEC BX-5, manufactured by Sekisui | | |
| Chemical Co., Ltd.) | | |
| Methyl ethyl ketone | 45.73 | parts |
| Toluene | 45.74 | parts |

### Example 14

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution AA having the following composition was applied by a gravure coating method so as to give the coverage on a dry basis of 0.8 g/m², and the resultant coating was dried to give a thermal transfer sheet of Example 14.

<Dye Layer Composition Solution AA>

| | | |
|---|---|---|
| Disperse Yellow 201 | 2.0 | parts |
| Disperse Yellow 231 | 2.0 | parts |
| Styrene skeleton-introduced acrylic | 3.33 | parts |
| polyol resin (Tg: 85° C.) | | |
| (COATAX LH-635 (60 wt % solution) manufactured | | |
| by Toray Fine Chemicals Co., Ltd.) | | |
| Polyvinyl acetoacetal resin | 2.0 | parts |
| (Tg: 110° C.) | | |
| (S-LEC KS-5, manufactured by | | |
| Sekisui Chemical Co., Ltd.) | | |
| Methyl ethyl ketone | 45.33 | parts |
| Toluene | 45.34 | parts |

### Example 15

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution BB having the following composition was applied by a gravure coating method so as to give the coverage on a dry basis of 0.8 g/m², and the resultant coating was dried to give a thermal transfer sheet of Example 15.

<Dye Layer Composition Solution BB>

| | | |
|---|---|---|
| Disperse Yellow 201 | 2.0 | parts |
| Disperse Yellow 231 | 2.0 | parts |
| Styrene skeleton-introduced acrylic polyol | 3.33 | parts |
| resin (Tg: 85° C.) | | |
| (COATAX LH-635 (60 wt % solution) manufactured | | |
| by Toray Fine Chemicals Co., Ltd.) | | |
| Polyvinyl butyral resin (Tg: 90° C.) | 2.0 | parts |
| (S-LEC BX-1, manufactured by Sekisui | | |
| Chemical Co., Ltd.) | | |
| Methyl ethyl ketone | 45.33 | parts |
| Toluene | 45.34 | parts |

### Example 16

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution CC having the following composition was applied by a gravure coating method so as to give the coverage on a dry basis of 0.6 g/m², and the resultant coating was dried to give a thermal transfer sheet of Example 16.

<Dye Layer Composition Solution CC>

| | | |
|---|---|---|
| Disperse Yellow 201 | 2.0 | parts |
| Disperse Yellow 231 | 2.0 | parts |
| Styrene skeleton-introduced acrylic | 6.67 | parts |
| polyol resin (Tg: 85° C.) | | |
| (COATAX LH-635 (60 wt % solution) manufactured | | |
| by Toray Fine Chemicals Co., Ltd.) | | |
| Methyl ethyl ketone | 44.66 | parts |
| Toluene | 44.67 | parts |

### Comparative Example 1

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution M having the following composition was applied by a gravure coating method so as to give the coverage on a dry basis of 0.8 g/m², and the resultant coating was dried to give a thermal transfer sheet of Comparative Example 1.

<Dye Layer Composition Solution M>

| | | |
|---|---|---|
| Disperse Yellow 201 | 2.0 | parts |
| Disperse Yellow 231 | 2.0 | parts |
| Polyvinyl butyral resin (Tg: 86° C.) | 4.0 | parts |
| (S-LEC BX-5, manufactured by Sekisui | | |
| Chemical Co., Ltd.) | | |
| Methyl ethyl ketone | 46.0 | parts |
| Toluene | 46.0 | parts |

### Comparative Example 2

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution N having the following composition was applied by a gravure coating method so as to give the coverage on a dry basis of 0.8 g/m², and the resultant coating was dried to give a thermal transfer sheet of Comparative Example 2.

<Dye Layer Composition Solution N>

| | | |
|---|---|---|
| Disperse Yellow 201 | 2.0 | parts |
| Disperse Yellow 231 | 2.0 | parts |
| Polyvinyl acetoacetal resin | 4.0 | parts |
| (Tg: 110° C.) | | |
| (S-LEC KS-5, manufactured by | | |
| Sekisui Chemical Co., Ltd.) | | |
| Methyl ethyl ketone | 46.0 | parts |
| Toluene | 46.0 | parts |

### Comparative Example 3

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution ◯ having the following composition was applied by a gravure coating method so as to give the coverage on a dry basis of 0.8 g/m², and the resultant coating was dried to give a thermal transfer sheet of Comparative Example 3.

<Dye Layer Composition Solution O>

| | | |
|---|---|---|
| Disperse Yellow 201 | 2.0 | parts |
| Disperse Yellow 231 | 2.0 | parts |
| Cellulose acetate butyrate resin | 4.0 | parts |
| (Tg: 141° C.) | | |
| (CAB 381-20, manufactured by Eastman | | |
| Chemical Company) | | |
| Methyl ethyl ketone | 46.0 | parts |
| Toluene | 46.0 | parts |

### Comparative Example 4

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution P having the following composition was applied by a gravure coating method so as to give the coverage on a dry basis of 0.8 g/m², and the resultant coating was dried to give a thermal transfer sheet of Comparative Example 4.

<Dye Layer Composition Solution P>

| | | |
|---|---|---|
| Solvent Blue 63 | 3.0 | parts |
| Disperse Blue 354 | 2.0 | parts |
| Polyvinyl butyral resin (Tg: 86° C.) | 4.0 | parts |
| (S-LEC BX-5, manufactured by Sekisui | | |
| Chemical Co., Ltd.) | | |
| Methyl ethyl ketone | 45.5 | parts |
| Toluene | 45.5 | parts |

### Comparative Example 5

A substrate which was prepared under the same conditions as those of Example 11 was used. A heat-resistant sliding layer as same as that of Example 1 was formed in advance on the surface opposite to the adhesiveness-improved surface. On the adhesiveness-improved surface of the substrate, a dye layer composition solution M which was used also in Comparative Example 1 was applied by a gravure coating method, without coating of an adhesive layer, so as to give the coverage on a dry basis of 0.8 g/m², and the resultant coating was dried to give a thermal transfer sheet of Comparative Example 5.

### Comparative Example 6

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution Q having the following composition was applied by a gravure coating method so as to give the coverage on a dry basis of 0.8 g/m², and the resultant coating was dried to give a thermal transfer sheet of Comparative Example 6.

<Dye Layer Composition Solution Q>

| | | |
|---|---|---|
| Disperse Yellow 201 | 2.0 | parts |
| Disperse Yellow 231 | 2.0 | parts |
| Styrene skeleton-unintroduced acrylic | 9.09 | parts |
| polyol resin (Tg: 70° C.) | | |
| (Acryt 6AN-493 (44 wt % solution) | | |
| manufactured by Taisei Kako Co., Ltd.) | | |
| Methyl ethyl ketone | 43.45 | parts |
| Toluene | 43.46 | parts |

### Comparative Example 7

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution R having the following composition was applied by a gravure coating method so as to give the coverage on a dry basis of 0.8 g/m², and the resultant coating was dried to give a thermal transfer sheet of Comparative Example 7.

<Dye Layer Composition Solution R>

| | | |
|---|---|---|
| Disperse Yellow 201 | 2.0 | parts |
| Disperse Yellow 231 | 2.0 | parts |
| Styrene skeleton-unintroduced | 10.0 | parts |
| acrylic polyol resin (Tg: 67° C.) | | |
| (Acrynal #1-193 (40 wt % solution) | | |
| manufactured by Toeikasei Co., Ltd.) | | |
| Methyl ethyl ketone | 43.0 | parts |
| Toluene | 43.0 | parts |

### Comparative Example 8

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution T having the following composition was applied by a gravure coating method so as to give the coverage on a dry basis of 0.8 g/m², and the resultant coating was dried to give a thermal transfer sheet of Comparative Example 8.

<Dye Layer Composition Solution T>

| | | |
|---|---|---|
| Disperse Yellow 201 | 2.0 | parts |
| Disperse Yellow 231 | 2.0 | parts |
| Styrene skeleton-unintroduced acrylic | 4.55 | parts |
| polyol resin (Tg: 70° C.) | | |
| (Acryt 6AN-493 (44 wt % solution) | | |
| manufactured by Taisei Kako Co., Ltd.) | | |
| Polyvinyl butyral resin (Tg: 86° C.) | 2.0 | parts |
| (S-LEC BX-5, manufactured by Sekisui | | |
| Chemical Co., Ltd.) | | |
| Methyl ethyl ketone | 44.72 | parts |
| Toluene | 44.73 | parts |

### Comparative Example 9

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution U having the following composition was applied by a gravure coating method so as to give the coverage on a dry basis of 0.8 g/m², and the resultant coating was dried to give a thermal transfer sheet of Comparative Example 9.

<Dye Layer Composition Solution U>

| | | |
|---|---|---|
| Disperse Yellow 201 | 2.0 | parts |
| Disperse Yellow 231 | 2.0 | parts |
| Styrene skeleton-unintroduced acrylic | 5.0 | parts |
| polyol resin (Tg: 67° C.) | | |
| (Acrynal #1-193 (40 wt % solution) | | |
| manufactured by Toeikasei Co., Ltd.) | | |
| Polyvinyl butyral resin (Tg: 86° C.) | 2.0 | parts |
| (S-LEC BX-5, manufactured by Sekisui | | |
| Chemical Co., Ltd.) | | |
| Methyl ethyl ketone | 44.5 | parts |
| Toluene | 44.5 | parts |

### Comparative Example 10

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution W having the following composition was applied by a gravure coating method so as to give the coverage on a dry basis of 0.8 g/m², and the resultant coating was dried to give a thermal transfer sheet of Comparative Example 10.

<Dye Layer Composition Solution W>

| | | |
|---|---|---|
| Disperse Yellow 201 | 2.0 | parts |
| Disperse Yellow 231 | 2.0 | parts |
| Styrene skeleton-unintroduced acrylic | 1.82 | parts |
| polyol resin (Tg: 70° C.) | | |
| (Acryt 6AN-493 (44 wt % solution) | | |
| manufactured by Taisei Kako Co., Ltd.) | | |
| Polyvinyl butyral resin (Tg: 86° C.) | 3.2 | parts |
| (S-LEC BX-5, manufactured by Sekisui | | |
| Chemical Co., Ltd.) | | |
| Methyl ethyl ketone | 45.49 | parts |
| Toluene | 45.49 | parts |

### Comparative Example 11

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution X having the following composition was applied by a gravure coating method so as to give the coverage on a dry basis of 0.8 g/m², and the resultant coating was dried to give a thermal transfer sheet of Comparative Example 11.

<Dye Layer Composition Solution X>

| | | |
|---|---|---|
| Disperse Yellow 201 | 2.0 | parts |
| Disperse Yellow 231 | 2.0 | parts |
| Styrene skeleton-unintroduced acrylic | 2.0 | parts |
| polyol resin (Tg: 67° C.) | | |
| (Acrynal #1-193 (40 wt % solution) | | |
| manufactured by Toeikasei Co., Ltd.) | | |
| Polyvinyl butyral resin (Tg: 86° C.) | 3.2 | parts |
| (S-LEC BX-5, manufactured by Sekisui | | |
| Chemical Co., Ltd.) | | |
| Methyl ethyl ketone | 45.4 | parts |
| Toluene | 45.4 | parts |

### Comparative Example 12

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution DD having the following composition was applied by a gravure coating method so as to give the coverage on a dry basis of 0.8 g/m², and the resultant coating was dried to give a thermal transfer sheet of Comparative Example 12.

<Dye Layer Composition Solution DD>

| | | |
|---|---|---|
| Disperse Yellow 201 | 2.0 | parts |
| Disperse Yellow 231 | 2.0 | parts |
| Polyvinyl butyral resin (Tg: 90° C.) | 4.0 | parts |
| (S-LEC BX-1, manufactured by Sekisui | | |
| Chemical Co., Ltd.) | | |
| Methyl ethyl ketone | 46.0 | parts |
| Toluene | 46.0 | parts |

### Comparative Example 13

A PET film substrate which was corona-treated under the same conditions as those of Example 1 was used. A heat-resistant sliding layer as same as that of Example 1 was formed in advance on the other surface of the substrate. On the corona-treated surface of the substrate, an adhesive layer as same as that of Example 1 was formed. Further on the adhesive layer, a dye layer composition solution FF having the following composition was applied by a gravure coating method so as to give the coverage on a dry basis of 0.8 g/m², and the resultant coating was dried to give a thermal transfer sheet of Comparative Example 13.

<Dye Layer Composition Solution FF>

| | | |
|---|---|---|
| Disperse Yellow 201 | 2.0 | parts |
| Disperse Yellow 231 | 2.0 | parts |
| Polyvinyl butyral resin (Tg: 90° C.) | 4.0 | parts |
| (S-LEC BX-5, manufactured by Sekisui | | |
| Chemical Co., Ltd.) | | |
| Methyl ethyl ketone | 46.0 | parts |
| Toluene | 46.0 | parts |

(Evaluation)

Using the thermal transfer sheets prepared in the Examples and the Comparative Examples, the printing densitity, the scumming and the dye migration to a heat-resistant sliding layer were evaluated by the methods described below.

(Printing Densitity Evaluation)

Printing was carried out under the following conditions and the density of the resulting printed article was measured.

The thermal transfer sheets prepared in Examples 1-16 and Comparative Examples 1-13 were subjected to printing using a Card PhotoPrinter CP-200 manufactured by Canon Inc. The density of a printed portion was measured using a Macbeth densitometer RD-918 (manufactured by Sakata Inx Corp.). The thermal transfer sheets were cut and stuck to a yellow panel portion of a genuine media (color ink/paper set KL-36IP) in Examples 1-4,6-9, 11-16 and Comparative Examples 1-3, 5-13, or to a cyan panel portion in Examples 5, 10 and Comparative Example 4. The samples in which a thermal transfer sheet was cut and stuck to the yellow panel portion was printed in a yellow solid print pattern (tone value: 255/255, density max.) and the samples in which a thermal transfer sheet was cut and stuck to the cyan panel portion was printed in a cyan solid print pattern (tone value: 255/255, density max.). The printing was carried out under an environment of 30° C. and 50%. As an image-receiving sheet, a genuine media (color ink/paper set KL-36IP) was used.

(Printing Densitity)

The color of the solid pattern-printed portion was measured at ten points and the average of the measurements was calculated. The average was compared with the average of a standard ribbon and was ranked as follows.
⊚: The density is not less than 110%.
◯: The density is not less than 103%, but less than 110%
Δ: The density is not less than 97%, but less than 103%.
X: The density is less than 97%.

The sheet of Comparative Example 1 is used as a standard ribbon in Examples 1-4, 6-7, 12-13 and Comparative Examples 6-11. The sheet of Comparative Example 4 is used as a standard ribbon in Examples 5 and 10. The sheet of Comparative Example 2 is used as a standard ribbon in Examples 8, 14. The sheet of Comparative Example 3 is used as a standard ribbon in Example 9. The sheet of Comparative Example 5 is used as a standard ribbon in Example 11. The sheet of Comparative Example 12 is used as a standard ribbon in Example 15. The sheet of Comparative Example 13 is used as a standard ribbon in Example 16.

(Scumming Evaluation)

Printing was carried out under the following conditions and the scumming was evaluated.

Thermal transfer sheets and image-receiving sheets as same as those used in the Printing densitity Evaluation were used. The thermal transfer sheets were cut and stuck to the thermal transfer sheets in the same manner as that used in the printing densitity evaluation. The print pattern was made in white solid (tone value=0/255; no printing heat) and the printing was carried out under an environment of 30° C. and 50%. The thermal transfer sheets prepared in Examples 1-16 and Comparative Example 1-13 were used after two-week storage at a temperature 40° C. and a humidity 90%.

<Standard of Scumming Evaluation>

⊚: The color difference between the image-receiving sheet before printing and the white solid printed portion, ΔE*ab, is less than 0.5.
◯: The color difference between the image-receiving sheet before printing and the white solid printed portion, ΔE*ab, is not less than 0.5, and less than 1.0.
Δ: The color difference between the image-receiving sheet before printing and the white solid printed portion, ΔE*ab, is not less than 1.0, and less than 1.5.
X: The color difference between the image-receiving sheet before printing and the white solid printed portion, ΔE*ab, is not less than 1.5.

The hue was measured using a GRETAG Spectrolino (D65 light source, view angle=2′) made by Gretag Co. The value was calculated according to the following equation.
ΔE*ab=((value L difference between a image-receiving sheet before printing and a white solid printed portion)²+(value a difference between a image-receiving sheet before printing and a white solid printed portion)²+(value b difference between a image-receiving sheet before printing and a white solid printed portion)²)^{1/2}
(Evaluation of Dye Migration to Heat-Resistant Sliding layer)

The dye migration to a heat-resistant sliding layer was evaluated under the following conditions.

Each of the thermal transfer sheets prepared in Examples 1-16 and Comparative Examples 1-13 were stored with the dye layer being faced to a heat-resistant sliding layer for 96 hours under an environment of 40° C. and 20% under a load 20 kg/cm². The heat-resistant sliding layer used was that prepared by applying the heat-resistant sliding layer composition solution (i) of Example 1 to the PET substrate used in Example 1 followed by drying under the conditions of Example 1 (an adhesive layer and a dye layer were not conducted).

<Standard of Evaluation of Dye Migration to Heat-Resistant Sliding Layer>

◯: The color difference of a heat-resistant sliding layer between before and after its superposition on a dye layer, ΔE*ab, is less than 1.5.
Δ: The color difference of a heat-resistant sliding layer between before and after its superposition on a dye layer, ΔE*ab, is not less than 1.5 and less than 3.0.
X: The color difference of a heat-resistant sliding layer between before and after its superposition on a dye layer, ΔE*ab, is not less than 3.0.

The hue was measured using a GRETAG Spectrolino (D65 light source, view angle=2′) made by Gretag Co. The value was calculated according to the following equation.
ΔE*ab=((value L difference between before and after superposition on the dye layer)²+(value a difference between before and after superposition on the dye layer)²+(value b difference between before and after superposition on the dye layer)²)^{1/2}

The results of the evaluations are shown in Table 1.

TABLE 1

| | | | Transferability |
|---|---|---|---|
| | | | of dye to heat |
| | Printing | | resistant |
| | density | Scumming | sliding layer |
| Example 1 | ⊚ | ◯ | ◯ |
| Example 2 | ⊚ | ◯ | ◯ |
| Example 3 | ⊚ | ◯ | ◯ |
| Example 4 | ⊚ | ◯ | ◯ |
| Example 5 | ⊚ | ◯ | ◯ |
| Example 6 | ⊚ | ⊚ | ◯ |
| Example 7 | ⊚ | ⊚ | ◯ |
| Example 8 | ⊚ | ⊚ | ◯ |
| Example 9 | ⊚ | ◯ | ◯ |
| Example 10 | ⊚ | ◯ | ◯ |
| Example 11 | ⊚ | ⊚ | ◯ |
| Example 12 | ◯ | ⊚ | ◯ |
| Example 13 | ◯ | ⊚ | ◯ |
| Example 14 | ⊚ | ⊚ | ◯ |
| Example 15 | ⊚ | ⊚ | ◯ |
| Example 16 | ⊚ | ⊚ | ◯ |
| Comparative Example 1 | — | ⊚ | ◯ |
| Comparative Example 2 | — | ⊚ | ◯ |
| Comparative Example 3 | — | ◯ | Δ |
| Comparative Example 4 | — | ◯ | ◯ |
| Comparative Example 5 | — | ⊚ | ◯ |
| Comparative Example 6 | X | Δ | X |
| Comparative Example 7 | X | Δ | X |
| Comparative Example 8 | X | Δ | Δ |
| Comparative Example 9 | X | Δ | Δ |
| Comparative Example 10 | Δ | ◯ | Δ |
| Comparative Example 11 | Δ | ◯ | Δ |
| Comparative Example 12 | — | ◯ | ◯ |
| Comparative Example 13 | — | ◯ | ◯ |

The above results show that when the (acrylic) polyol resin having a styrene skeleton is contained in a binder resin of a dye layer is used, the scumming and the migration of dyes to a heat-resistant sliding layer can be prevented while a high transfer density is achieved during the thermal transfer, being excellent in suitability for printing, when compared with the case where (acrylic) polyol having no styrene skeleton is used.

By setting the glass transition temperature (Tg) to 40° C. or higher, the scumming and the migration of dyes to a heat-resistant sliding layer are prevented and excellent in suitability for printing.

1. A thermal transfer sheet, comprising a substrate;
a heat-resistant sliding layer provided on one surface of the substrate; and a dye layer comprising at least a dye and a binder resin provided on the other surface of the substrate,
wherein the binder resin comprises a styrene-containing polyol resin.

2. The thermal transfer sheet according to claim 1, wherein the polyol is acrylic polyol.

3. The thermal transfer sheet according to claim 1, wherein the styrene-containing polyol resin has a glass transition temperature (Tg) between 40° C. or higher and 110° C. or less.

4. The thermal transfer sheet according to claim 1, wherein the binder resin further comprises a polyvinyl butyral.

5. The thermal transfer sheet according to claim 1, wherein the binder resin further comprises a polyvinyl acetoacetal.

6. The thermal transfer sheet according to claim 1, wherein the styrene-containing polyol resins includes a styrene-type monomer and hydroxyalkyl (meth)acrylate as constitutional monomer units.

7. The thermal transfer sheet according to claim 6, wherein a copolymerization ratio (molar ratio) (styrene-type monomer:hydroxyalkyl (meth)acrylate) is 95:5-5:95.

8. The thermal transfer sheet according to one of claims 1 to 7, wherein the styrene-containing polyol resin is contained at a ratio of 10-100% by weight in the binder resin in the dye layer.
